(19) United States
(12) Patent Application Publication
(10) Pub. No.: US 2026/0163883 A1
(43) Pub. Date: Jun. 11, 2026

(54) METHODS AND APPARATUS FOR FACILITATING OPERATION OF REMOTE AGENTS IN CHALLENGING ENVIRONMENTS

(71) Applicant: Rivet Industries, Inc., Washington, DC (US)

(72) Inventors: Seyedsohrab MADANI, Menlo Park, CA (US); Jouya JADIDIAN, Los Gatos, CA (US); Mohit NARANG, Cupertino, CA (US)

(21) Appl. No.: 19/196,636

(22) Filed: May 1, 2025

Related U.S. Application Data
(60) Provisional application No. 63/656,168, filed on Jun. 5, 2024.

(51) Int. Cl. H04L 9/40

(52) U.S. Cl. CPC H04L 63/0876; B64U 20/00; G01S 13/00; G06F 21/44; H03C 1/46

(57) ABSTRACT

An apparatus includes a mechanical modulator. The mechanical modulator includes a panel and reflectors. The panel has a surface with an aperture. The surface has an absorptive material to prevent a transmission of a first photons. The panel is moveable relative to the reflectors. The reflectors are configured to receive the first photons through the aperture of the surface and to modulate the first photons in response to a motion of the panel to reflect a second photons through the aperture of the surface. The second photons represent an identity of a first compute device. The first compute device is co-located with the mechanical modulator within an environment. The first compute device is configured to receive, from a second compute device, data in response to the second compute device verifying the identity of the first compute device based on the second photons.

### CROSS-REFERENCE TO RELATED APPLICATION

This patent application claims priority to U.S. Provisional Ser. No. 63/656,168, filed on Jun. 5, 2024 and titled “Methods and Apparatus for Facilitating Operation of Agents in Challenging Environments,” which is incorporated by reference in its entirety.

### FIELD

The present disclosure relates to field of facilitating operation of agents in challenging environments.

### BACKGROUND

It is often desirable for mobile computer-based systems to determine their locations for example, through the use of Global Positioning System (GPS). Sometimes, however, the mobile computer-based systems operate and navigate in environments without access to Global Positioning System (GPS) signals. It may be the case that the mobile computer-based systems operate in coordination with an overhead drone (e.g., an unmanned aerial vehicle (UAV)). In such environments, a need exists for mobile computer-based systems to operate and navigate without using GPS.

### SUMMARY

In some embodiments, an apparatus includes a mechanical modulator. The mechanical modulator includes a panel and a plurality of reflectors. The panel has a surface with an aperture. The surface has an absorptive material to substantially prevent a transmission of a first plurality of photons. The panel is moveable relative to the plurality of reflectors. The plurality of reflectors is configured to receive the first plurality of photons through the aperture of the surface and to modulate the first plurality of photons in response to a motion of the panel to reflect a second plurality of photons through the aperture of the surface. The second plurality of photons is a representation of an identity of a first compute device. The first compute device is co-located with the mechanical modulator within an environment. The first compute device is configured to receive, from a second compute device, data at a memory operably coupled to a processor of the first compute device in response to the second compute device verifying the identity of the first compute device based on the second plurality of photons.

In some embodiments, a method includes sending, to a mechanical modulator co-located with a first compute device within an environment and from a transmitter of a second compute device, a first plurality of photons. The method further includes receiving, at a receiver of the second compute device and from the mechanical modulator, a second plurality of photons based on a modulation of the first plurality of photons. The method further includes identifying, using a processor of the second compute device, a first sequence of values specified by movements of the mechanical modulator, based on the second plurality of photons. The method further includes comparing, using the processor, the first sequence of values to a second sequence of values stored in a memory of the second compute device to verify an identity of the second compute device. The second sequence of values was previously defined as being associated with the identity of the first compute device. The method further includes sending, in response to verifying the identity of the first compute device and from the second compute device and to the first compute device, data.

### BRIEF DESCRIPTION OF THE DRAWINGS

FIG. 1 is a block diagram of a system that includes an agent compute device and a coordinating agent compute device, according to an embodiment.

FIG. 2 is a flow chart showing a method of operation of an agent compute device and a coordinating agent compute device, according to an embodiment.

FIG. 3A is an example illustration of a mechanical modulator at a position of a predefined sequence of positions, according to an embodiment.

FIG. 3B is an example illustration of a mechanical modulator at a position of a predefined sequence of positions, according to an embodiment.

FIG. 4 is a flowchart of an example method for a handshake, according to an embodiment.

### DETAILED DESCRIPTION

One or more embodiments relate to agents (e.g., individuals, robots, drones, vehicles, etc.) self-localizing in environments without access to Global Positioning System (GPS) signals. Such agents can operate, for example, on the ground and can be referred to herein as “agents” or “ground agents” or “ground agent compute devices”. Such agents can be understood to have an absence of GPS signals. For example, the ground agents can operate in coordination with a different agent such as an overhead drone (e.g., an unmanned aerial vehicle (UAV)) also referred to herein as a “coordinating agent”, a “coordinating agent compute device” or a “mobile coordinating agent compute device”. The coordinating agent can, for example, include sensors that allow the coordinating agent to continuously map the terrain of the environment where the coordinating agent and the other agents are operating. The coordinating agent can perform a handshaking with each ground agent, for example, that uses passive retroreflection modulation to complete its portion of the handshaking. Once the handshaking is complete, the coordinating agent can then download the map to that ground agent and repeat the process for any remaining ground agents.

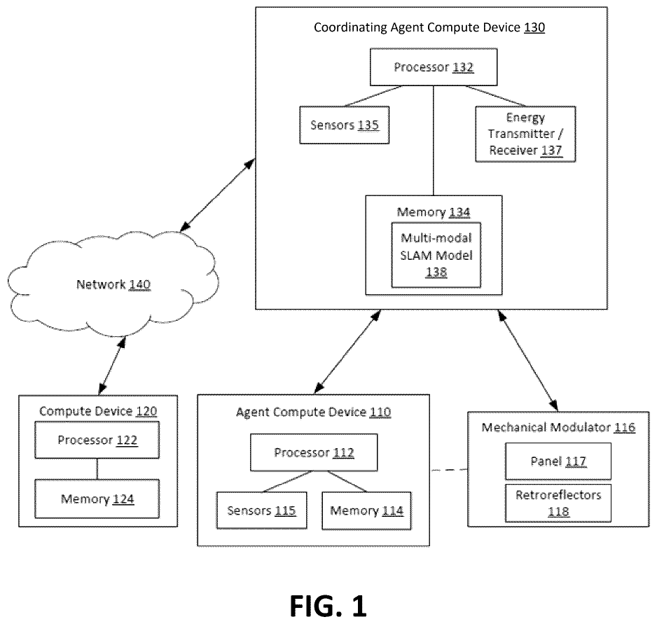

FIG. 1 is a block diagram of a system that includes an agent compute device and a coordinating agent compute device, according to an embodiment. As shown in FIG. 1, the system includes an agent compute device 110, a compute device 120, a coordinating agent compute device 130, and a mechanical modulator 116. Compute device 120 and coordinating agent compute device 130 are coupled together by a communications network 140. The mechanical modulator 116 is associated with agent compute device 110, for example, because the same given user/agent can have access to and use both the agent compute device 110 and the mechanical modulator 116. Similarly, the mechanical modulator 116 is co-located with agent compute device 110 in the environment, for example, because the mechanical modulator 116 and agent compute device 110 can be positioned to receive communications from the coordinating agent compute device 130 within a directional cone of energy over a spectral bandwidth. While only a single combination of the agent compute device 110 and the mechanical modulator 116 are shown in FIG. 1, it should be understood that multiple such combinations are possible, including for example, multiple combinations of an agent compute device 110 and mechanical modulator 116 for a given coordinating agent compute device 130.

The agent compute device 110 can have, for example, a processor 112, a memory 114, sensors 115 and a communications interface (not shown). The processor 112 can be coupled to the memory 114, the sensors 115 and the communications interface. The processor 112 (e.g., a coordinating processing unit (CPU), a graphics processing unit (GPU), and/or the like) can be, for example, a hardware-based integrated circuit (IC) or any other suitable processing device configured to run or execute a set of instructions or codes. The memory 114 (e.g., a random-access memory (RAM), a hard drive, a flash drive, a solid-state drive, and/or the like) of the agent compute device 110 can store data, and/or code that includes instructions to cause the processor 112 to perform one or more processes or functions. The communication interface (e.g., a network interface card (NIC), a Wi-Fi® transceiver, a Bluetooth® transceiver, and/or the like) can be a hardware component that facilitates data communication between agent compute device 110 and other devices (e.g., the coordinating agent compute device 130). The sensors 115 can include a combination of two or more sensors with two or more sensor types. For example, the sensors 115 can include an inertial measurement unit (IMU), an accelerometer, a gyroscope, a camera, a red-green-blue (RGB) camera, a low light camera, a thermal imager, a WiFi® sensor (or a WiFi® transceiver or a WiFi® receiver), a radar sensor, a magnetometer, and/or etc. The sensors 115 are presumed to not include a GPS sensor, or if a GPS sensor is included, then the GPS sensor is assumed to not operate properly given the GPS-denied environment. Therefore, the agent compute device 110 can be understood to have an absence of GPS signals.

The user of the agent compute device 110 can have access to and can use a mechanical modulator 116. The mechanical modulator 116 can be, for example, a passive device that includes multiple retroflectors 118 disposed behind a panel 117 with an aperture. The panel 117 can be an absorptive material or can have an absorptive surface that absorbs incident energy while the aperture of the panel 117 allows the remaining incident energy to pass through the aperture. The panel 117 can be a moveable panel relative to the retroreflectors 118. The panel 117 can be, for example, a panel rotatably and/or translationally coupled to the multiple retroreflectors 118 such that the aperture of the panel 117 can be selectively disposed over one retroreflector from the multiple retroreflectors 118. For example, the multiple retroreflectors 118 can be fixed coupled to a base that is moveably coupled to the panel 117. This allows a user of the ground agent compute device 110 to rotate and/or translate the panel 117 to select one retroreflector while covering/ obstructing the remaining retroreflectors from the multiple retroreflectors 118.

Each retroreflector from the multiple retroreflectors 118 can be, for example, a passive device that reflects energy back along the incident path regardless of the angle of incidence. More specifically, upon receiving energy from the coordinating agent compute device 130, the user of the agent compute device 110 can rotate and/or translate the panel 117 through a predefined sequence of positions so that a predefined sequence of individual retroreflectors is exposed to the incident energy and reflects to the coordinating agent compute device 130 according to the predefined sequence.

Each retroreflector from the multiple retroreflectors 118 can be uniquely associated with a different spectral band and can have a different reflection coefficient(s). For example, the coordinating agent compute device 130 can send to the mechanical modulator 116 co-located with the agent compute device 110 energy (e.g., radio frequency (RF) energy) within a directional cone over a spectral bandwidth. This incident energy can be received at the mechanical modulator 116 such that energy incident on the panel 117 is substantially absorbed (e.g., sufficiently absorbed to avoid undesirable reflections such as 90% absorbed, 95% absorbed, 99% absorbed, etc.) and the energy incident at the aperture of the panel 117 passes through the aperture and is received by the one retroreflector that in turn can reflect a subset of the received energy within the spectral band/response of that retroreflector and at an amplitude dependent on the reflection coefficient(s) for that retroreflector. As such, a user can select specific retroflectors from the multiple retroreflectors 118 in a predefined sequence and the energy retroreflected back to the coordinating agent compute device 130 from each retroreflector will be in a spectral band that is a subset of the wider spectral band of the energy sent by the coordinating agent compute device 130 and with an amplitude associated with the reflection coefficient(s) for that retroreflector. In sum, the selection of different retroreflectors 118 can be considered as resulting in both frequency and amplitude modulation (due to frequency response and reflectivity of each retroreflector) that produces a low data-rate signal from the agent compute device 110 to the coordinating agent compute device 130. Moreover, the timing involved in the user/agent in selecting retroreflectors within the predefined sequence also adds a time modulation.

As part of a handshaking process between the coordinating agent compute device 130 and the agent compute device 110, the mechanical modulator 116 allows the user of the agent compute device 110 to indicate whether the agent compute device 110 is ready (or available or clear) to receive a communication (e.g., data) from the coordinating agent compute device 130 such as a download of a map of the environment/region within which the agent compute device 110 is operating. Upon receiving the reflected energy in the predefined sequence of individual spectral bands (and the expected amplitudes and/or with the expected timing), the coordinating agent compute device 130 can determine that the agent compute device 110 is ready (or available or clear) to receive a communication from the coordinating agent compute device 130. The coordinating agent compute device 130 can initiate (e.g., automatically initiate) the communication/download such as the download of a map.

In some implementations, the predefined sequence of positions of the panel 117 can be selected by the user further based on a predefined time periods. For example, rather than rotating the panel 117 through the predefined sequence of positions independent of the amount of time at each position, the user can position the panel 117 at each position within the sequence of positions for a fixed amount of time at each position or at a time varying amount of time at each position. For example, the user can position the panel 117 at each position within the sequence of positions for a predefined sequence of time periods such as position 1 for 10 seconds, position 2 for 5 seconds, and position 3 for 15 seconds. In this manner, the handshake process can incorporate the predefined time sequence in addition to the predefined position sequence.

The compute device 120 can include, for example, a processor 122, a memory 124, and a communications interface (not shown). The processor 122, the memory 124 and the communications interface of compute device 120 can be similar to the processor 112, the memory 114 and the communications interface of agent compute device 110. The memory 124 can include various software modules and/or machine learning models. The compute device 120 can, for example, train a machine learning model(s) and then send it to coordinating agent compute device 130 for later use in the inference phase. In alternative embodiments, the compute device 120 is optional. The machine learning model can include, for example, a supervised machine learning model and/or an unsupervised machine learning model. The machine learning model can include, for example, a convolutional neural network (CNN), a recurrent neural network (RNN) and/or any neural network. In some implementations, the coordinating agent compute device 130 can input data (e.g., a map, etc.) to the machine learning model to predict other data (e.g., characteristics and/or quantifications of the map, such as a number of compute devices detected, a number of resources detected in the environment (e.g., rivers, trees, mountains, buildings, vehicles, etc.), etc.).

The coordinating agent compute device 130 can coordinate communications with one or more agent compute devices 110. In other words, in at least one embodiment/implementation, the agent compute devices 110 do not communicate between themselves but rather each agent compute device 110 communicates with coordinating agent compute device 130. In some implementations, the coordinating agent compute device 130 can be a compute device that controls operation of a UAV (e.g., a drone, etc.). The coordinating agent compute device 130 can have, for example, a processor 132, a memory 134, sensors 135, an energy transmitter/receiver 137 and a communications interface (not shown). The processor 132 can be coupled to the memory 134, the sensors 135, the energy transmitter/receiver 137 and the communications interface. The processor 132 (e.g., a coordinating processing unit (CPU), a graphics processing unit (GPU), and/or the like) can be, for example, structurally similar to the processor 112. The memory 134 (e.g., a random-access memory (RAM), a hard drive, a flash drive, and/or the like) of coordinating agent compute device 130 can store data, and/or code that includes instructions to cause the processor 132 to perform one or more processes or functions. The memory 134 can store multi-modal simultaneous localization and mapping (SLAM) model 138, which can be used for the coordinating agent compute device 130 to perform self-localization and generate a map such as a terrain map of the area in which the coordinating agent compute device 130 is operating. The sensors 135 can include a combination of two or more sensors with two or more sensor types. For example, the sensors 135 can include an inertial measurement unit (IMU), an accelerometer, a gyroscope, a camera, a red-green-blue (RGB) camera, a low light camera, a thermal imager, a WiFi® sensor (or a WiFi® transceiver or a WiFi® receiver), a radar sensor, a magnetometer, etc. The energy transmitter/ receiver 137 can be, for example, a radio frequency (RF) transceiver that can send energy to an agent compute device(s) 110 in a directionally narrow cone and receive the reflected energy from the mechanical modulator 116 associated with the agent compute device 110. The communication interface (e.g., a network interface card (NIC), a Wi-Fi® transceiver, a Bluetooth® transceiver, and/or the like) can be a hardware component that facilitates data communication between coordinating agent compute device 130 and other devices (e.g., the agent compute device 110, the compute device 120, compute devices coupled to communications network 140 but shown in FIG. 1, and/or the like).

In some implementations, the coordinating agent compute device 130 can define a predefined sequence of spectral bands for each agent compute device (e.g., the agent compute device 110) within the environment. In some instances, the predefined sequence of spectral bands can be unique to a designated agent compute device, a predefined location, a predefined time period, and/or a predefined objective, and can be reused. For example, the coordinating agent compute device 130 can predefine one or more sequences of spectral bands that the coordinating agent compute device 130 expects to receive when agent compute devices (co-located with a mechanical modulator) are in a predefined location (e.g., proximity to a predefined location). Instead, or in addition, the coordinating agent compute device 130 can predefine one or more sequences of spectral bands that the coordinating agent compute device 130 expects to receive from agent compute devices during a predefined time period (e.g., within the range of up to 1 day, 1 week, 1 month, 3 months, 6 months, or 1 year or more). Instead, or in addition, the coordinating agent compute device 130 can predefine one or more sequences of spectral bands that the coordinating agent compute device 130 expects to receive from agent compute devices tasked with carrying out an operation towards completing an objective. A compute device (e.g., the compute device 120, the coordinating agent compute device 130, or another compute device not shown in FIG. 1) can predefine the location(s), time period(s), and/or objective(s). The coordinating agent compute device 130 can store reference(s) to location(s), time period(s), or objective(s) associated with the predefined sequence of spectral bands at the memory 134 (e.g., as entries of a table of a database), and can recall the reference(s) from the memory 134 when verifying a predefined sequence of spectral bands in an environment without receiving GPS signal. The coordinating agent compute device 130 can thereby expect to receive the predefined sequence of spectral bands from any amount of agent compute device(s) that are within or near a particular predefined location, during a predefine time period, or have a predefined objective such that the predefined sequence of spectral bands can be understood to be “reusable”.

In some instances, the predefined sequence of spectral bands can be common to one or more agent compute device(s) and can therefore represent an identity of the one or more agent compute device(s). The coordinating agent compute device 130 can store at the memory 134 the predefined sequence of spectral bands as a sequence of property values of the energy/photons that define each spectral band (e.g., as entries of a table of a database), with reference(s) to identifiers associated with the one or more agent compute device(s). The property values of the energy/photons can be and/or include, for example, an expected optical signal amplitude (e.g., 10 μV/m, 10 mV/m, 1 V/m, 10 μV, 10 mV, 1 V, etc.), an expected optical signal frequency (e.g., within a range of 3 kHz to 300 GHz etc.), an expected optical signal wavelength (e.g., within a range of 1 mm to 100 km), and/or the like as detected/measured at the receiver of the energy transmitter/receiver 137 (or another optical measurement component, not shown in FIG. 1). Additionally, the coordinating agent compute device 130 can check for a time delay among the energy/photons defining each spectral band into the predefined sequence of spectral bands. For example, the coordinating agent compute device 130 can expect to receive a first energy/photons at a time t₁ and expect to receive a second energy/photons at a time t₂, where the time delay is measured as t₂−t₁. The coordinating agent compute device 130 can predefine and store a reference to time delay(s) as, for example, an entry in the table in the database, at the memory 134, and can compare the reference to time delay(s) associated with a predefined sequence of spectral bands to time delay(s) of a received sequence of spectral bands. The coordinating agent compute device 130 can predefine time delay(s) based on expectations for how much time a user/agent of the agent compute device 110 can move the panel 117 of the mechanical modulator 116 through the predefined sequence of positions. For example, a user/agent can be expected to take in the range of up to 5 s, up to 10 s, up to 30 s, or up to several minutes or more to move the panel 117, depending on conditions of the environment in which the agent compute device 110 is within (e.g., weather conditions, hostile conditions, etc.).

In some such implementations, for example, the coordinating agent compute device 130 can receive energy/photons that define a received sequence of spectral bands in response to motions of the panel 117 of the mechanical modulator 116 that define a sequence of positions. The coordinating agent compute device 130 can measure property values of the energy/photons of the received sequence of spectral bands at the energy transmitter/receiver 137 to produce measured property values. The processor 132 can, for example, update the table of the database having the expected property values and stored at the memory 134 with entries for the measured property values. The processor 132 can compare the entries of the expected property values to the entries of the measured property values to determine a substantial match between the (expected) predefined sequence of spectral bands and the received sequence of spectral bands. A substantial match can mean the received sequence of spectral bands and/or the measured property values are a less than perfect match (e.g., match within 99%, 98%, 95%, or 90%) to the predefined sequence of spectral bands and/or expected property values. By determining the substantial match, the processor 132 can be understood to have verified the predefined sequence of spectral bands, and therefore, an identity of the agent compute device 110. The coordinating agent compute device 130 can send data (e.g., a map, etc.) to the agent compute device 110 in response to verifying the predefined sequence of spectral bands.

In some implementations, the coordinating agent compute device 130 can define multiple predefined sequences of spectral bands (e.g., sequences each having 2, 5, 10, or more spectral bands) for one or more agent compute devices in the field. For example, a user/agent of the agent compute device 110 can move the panel 117 of the mechanical modulator 116 according to any one of multiple predefined sequence of positions that are associated with the multiple predefined sequences of spectral bands. In response, the coordinating agent compute device 130 at the energy transmitter/receiver 137 can receive energy/photons that define any one of the multiple predefined sequences of spectral bands, and the coordinating agent compute device 130 can verify any one of the multiple predefined sequences of spectral bands. The coordinating agent compute device 130 can send data (e.g., a map, etc.) to the agent compute device 110 in response to verifying any one of the multiple predefined sequences of spectral bands (and therefore, an identity of the agent compute device 110).

In some implementations, the compute device 120 can define the predefined sequence of spectral bands for each compute device in the field and can store the predefined sequence as a sequence of expected property values of the energy/photons that define each spectral band at the memory 124 (e.g., as entries of a table of a database). The compute device 120 can send the data that represents that predefined sequence of spectral bands to the coordinating agent compute device 130 via the network 140.

The communications network 140 can be any suitable communications network for transferring data, operating over public and/or private communications networks. For example, the communications network 140 can include a private network, a Virtual Private Network (VPN), a Multiprotocol Label Switching (MPLS) circuit, the Internet, an intranet, a local area network (LAN), a wide area network (WAN), a metropolitan area network (MAN), a worldwide interoperability for microwave access network (WiMAX®), an optical fiber (or fiber optic)-based network, a Bluetooth® network, a virtual network, and/or any combination thereof. In some instances, the communications network 140 can be a wireless network such as, for example, a Wi-Fi or wireless local area network (“WLAN”), a wireless wide area network (“WWAN”), and/or a cellular network. In other instances, the communications network 140 can be a wired network such as, for example, an Ethernet network, a digital subscription line (“DSL”) network, a broadband network, and/or a fiber-optic network. The communications sent via the communications network 140 can be encrypted or unencrypted. In some instances, the communications network 140 can include multiple networks or subnetworks operatively coupled to one another by, for example, network bridges, routers, switches, gateways and/or the like.

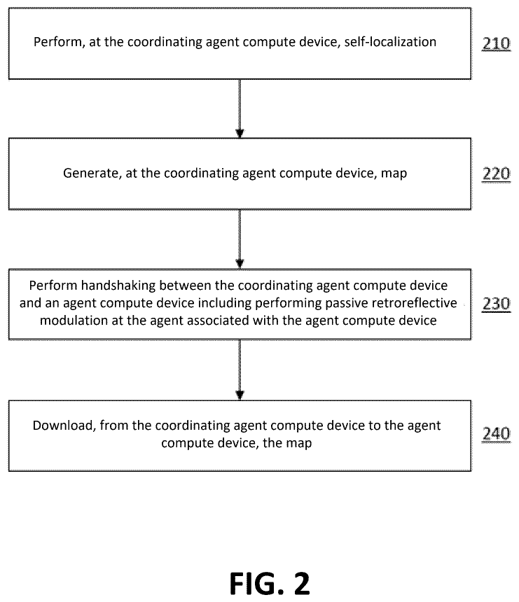

FIG. 2 is a flow chart showing a method of operation of an agent compute device and a coordinating agent compute device, according to an embodiment. As shown in FIG. 2, at 210, the coordinating agent compute device (e.g., the coordinating agent compute device 130 of FIG. 1) can perform self-localization using, for example, data collected by its sensors (e.g., the sensors 135 of FIG. 1) and using a multi-model SLAM model (e.g., the multi-modal SLAM model 138 of FIG. 1). At 220, the coordinating agent compute device can generate a map, for example, continuously generate a map of the terrain within an environment around the coordinating agent compute device as it moves (e.g., as it flies when the coordinating agent compute device is a UAV).

At 230, the coordinating agent compute device 130 and the agent compute device 110 can perform handshaking to identify when the agent compute device 110 is ready (or available or clear) to receive a communication from the coordinating agent compute device 130 such as a download of a map of the region within the agent compute device 110 is operating. In other words, the coordinating agent compute device 130 and the agent compute device 110 can perform handshaking for example through the exchange of predefined sequences of energy to establish a one-way communication from the coordinating agent compute device 130 to the agent compute device 110 for a larger communication such as downloading a map of the region/environment within which the agent compute device 110 is operating.

The handshaking can be performed, for example, by the transmitter of the energy transmitter/receiver 137 of the coordinating agent compute device 130 sending energy (e.g., energy in a directionally narrow cone over a spectral band) to the user/agent using the agent compute device 110. Upon receiving energy from the coordinating agent compute device 130, the user/agent of the agent compute device 110 can rotate and/or translate the panel 117 through a predefined sequence of positions so that a predefined sequence of individual retroreflectors is exposed to the incident energy and reflects to the coordinating agent compute device 130 a predefined sequence of individual spectral bands. Upon receiving the reflected energy in the predefined sequence of individual spectral bands, the coordinating agent compute device 130 can determine that the agent compute device 110 is ready (or available or clear) to receive a communication from the coordinating agent compute device 130; the coordinating agent compute device 130 can initiate (e.g., automatically initiate) the communication/download such as the download of a map.

In some implementations, the coordinating agent compute device 130 can assess the quality of the transmission between the coordinating agent compute device 130 and the agent compute device 110 and then move closer to the user/agent of the coordinating agent compute device 130 until a sufficient transmission quality is established. For example, the coordinating agent compute device 130 can measure the strength (amplitude) of the energy received back from the retroreflectors 118 and assess the signal-to-noise ratio (or transmissivity or bandwidth) to assess the quality of the transmission for the subsequent downloading/transmission of a copy of the map as discussed below with respect to 240. In some instances, sufficient transmission quality can mean that the transmission quality meets or surpasses a predefined transmission quality threshold value (e.g., a predefined amplitude threshold value and/or a predefined signal-to-noise threshold value of the energy received back, etc.).

In some implementations, the predefined sequence of positions of the panel 117 can be selected by the user further based on a time. For example, rather than rotating the panel 117 through the predefined sequence of positions independent of the amount of time at each position, the user can position the panel 117 at each position within the sequence of positions for a fixed amount of time at each position or at a time varying amount of time at each position. For example, the user can position the panel 117 at each position within the sequence of positions for a predefined sequence of time periods such as position 1 for 10 seconds, position 2 for 5 seconds, and position 3 for 15 seconds. In this manner, the handshake process can take into account the predefined time sequence in addition to the predefined position sequence.

In some other implementations, the panel 117 can be configured differently and/or used differently. For example, in some alternative implementations, the positions of the panel can expose more than one retroreflector (e.g., two retroreflectors at a time) to incident energy from the coordinating agent compute device 130. In such an implementation, the coordinating agent compute device 130 can send a relatively wide spectral band of energy and the panel 117 can return two different narrower spectral bands of energy for each position of the panel within a predefined sequence of positions of the panel 117. In yet another implementation, the panel 117 can be moved through the predefined sequence of positions by a motor/actuator that automatically moves the panel 117 without human intervention. The motor/actuator can initiate the predefined sequence of positions, for example, by the agent/user activating the motor/actuator (e.g., by pushing a start button). In yet another alternative, the predefined sequence of positions can be from a set of multiple predefined sequence of positions. A particular predefined sequence of positions from the set of multiple predefined sequence of positions for a given situation/time period/location can be selected by the agent/user.

Returning to FIG. 2, at 240, the coordinating agent compute device 130 can download a copy of the map to the agent compute device 110 in response to the handshaking process being successful (e.g., upon the receiver of the energy transmitter/receiver 137 of FIG. 1 receiving and the processor 132 verifying an expected predefined sequence of spectral bands associated with the predefined sequence of positions of the panel 117), allowing the agent compute device 110 to perform self-localization using the map. In some implementations, the expected predefined sequence of spectral bands can represent an identity of one or more agent compute devices, including the agent compute device 110. Once the copy of the map has been transmitted/sent to the agent compute device 110 for a sufficient amount of time for the agent compute device 110 to successfully download the map given the bandwidth available at the coordinating agent compute device 130, then the coordinating agent compute device 130 can move away from that agent compute device 110 and move towards a different agent compute device 110 that has not yet received a download of the map. The process of FIG. 2 can be repeated for each agent compute device 110 within the relevant operational region of coordinating agent compute device 130 until every such agent compute device 110 has received a map from coordinating agent compute device 130. In fact, that overall process can be repeated to the extent that the map has been updated by coordinating agent compute device 130 and it is desirable to provide the updated map to agent compute devices 110. In some environments, the coordinating agent compute device 130 can have an absence of GPS signals.

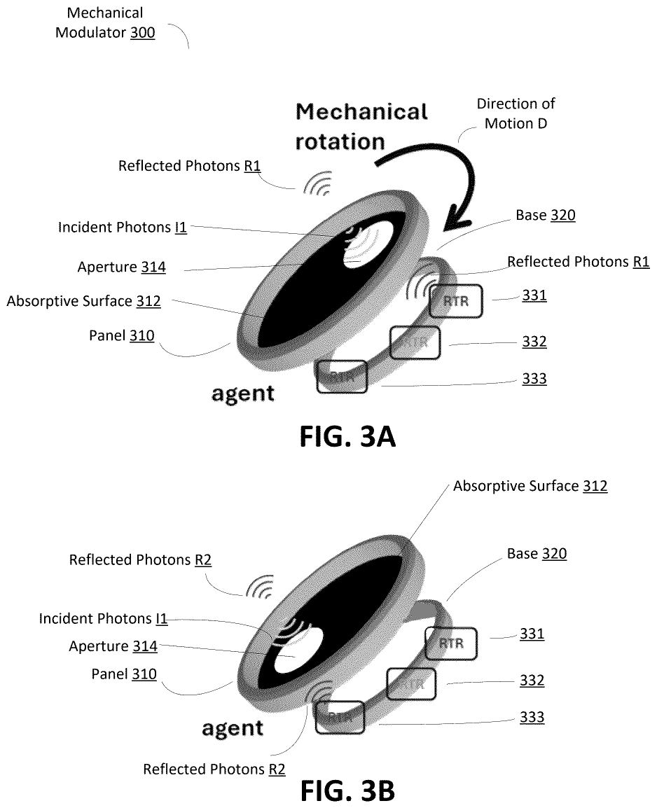

FIG. 3A is an example illustration of a mechanical modulator 300 at a position of a predefined sequence of positions, according to an embodiment. The mechanical modulator 300 can be structurally and/or functionally similar to the mechanical modulator 116 of FIG. 1. The mechanical modulator 300 can be associated with and/or co-located with an agent compute device (e.g., the agent compute device 110 of FIG. 1, not shown in FIG. 3A) and can be configured to receive energy/photons from a coordinating agent compute device (e.g., the coordinating agent compute device 130 of FIG. 1, not shown in FIG. 3A). The mechanical modulator 300 includes a panel 310, a base 320, a retroreflector (RTR) 331, a retroreflector (RTR) 332, and a retroreflector (RTR) 333. The panel 310 includes an absorptive surface 312 with an aperture 314. As shown in FIG. 3A, the position of the panel 310 can expose the RTR 331 to incident photons Il while covering the RTR 332 and the RTR 333.

The panel 310 can be structurally and/or functionally similar to the panel 117 in FIG. 1. The panel 310 can be moveable relative to the RTR 331, the RTR 332, the RTR 333, and other retroreflectors not shown in FIG. 3A. The absorptive surface 312 of the panel can be any material suitable to substantially prevent a transmission of the incident photons I1 (e.g., such that the absorptive surface 312 sufficiently absorbs photons to avoid undesirable transmissions and/or reflections such as 90% absorbed, 95% absorbed, 99% absorbed, etc.). The aperture 314 can permit a transmission of the incident photons I1 to the RTR 331. The direction of motion D can be a direction of a mechanical rotation of the panel 310 relative to the base 320. In some implementations, the direction of motion D can be a direction of a mechanical translation of the panel 310 relative to the base 320. While the direction of motion D is shown in FIG. 3A as a clockwise direction of a mechanical rotation of the panel 310 relative to the base 320, the direction of motion D can be a counterclockwise direction. Furthermore, the panel 310 can be mechanically rotated and/or mechanically translated relative to the base 320 by any amount of motion and/or more than one time.

The base 320 can be any material suitable for fixedly coupling of the RTR 331, RTR 332, RTR 333, and/or other retroreflectors not shown in FIG. 3A. For example, the base 320 can be a metal, plastic, a rubber, a glass, a wood, a fabric, and/or the like. The retroreflectors can be fixedly coupled to the base 320 using, for example, adhesives such as epoxy, silicone adhesives, and/or acrylic-based bonding agents. The base 320 can be moveably (e.g., rotatably) coupled to the panel 310 such that a motion of the panel 310 does not change a position of the base 320 and/or the RTR 331, RTR 332, and RTR 333.

The RTR 331, the RTR 332, and the RTR 333 can be structurally and/or functionally similar to the retroreflectors 118 of FIG. 1. The RTR 331 can have a reflection coefficient different from a reflection coefficient of the RTR 332 and a reflection coefficient of the RTR 333. Similarly, the RTR 331 can have a spectral response different from a spectral response of the RTR 332 and a spectral response of the RTR 333. In response to receiving incident photons Il having, for example, a broad spectral band with a distribution of wavelengths and amplitude ai, the RTR 331 can reflect the incident photons Il to produce reflected photons R1. The RTR 331 can have a spectral response such that the reflected photons R1 may have narrower spectral band than the broad spectral band of the incident photons I1. Therefore, the spectral response of the RTR 331 can define a frequency modulation and/or frequency filtering of the incident photons I1. The RTR 331 can have a reflection coefficient that defines an amplitude a₂ of the reflected photons R1, which can be different from (e.g., less than) the amplitude a₁ of the incident photons I1. Therefore, in some implementations, the reflection coefficient of the RTR 331 can define an amplitude modulation of the incident photons I1.

In some implementations, for example, the mechanical modulator 300 can receive incident photons I1 at the RTR 331 through the aperture 314 of the absorptive surface 312 according to a first position of a predefined sequence of positions. The incident photons I1 can be sent by a coordinating agent compute device (not shown in FIG. 3A). In response to receiving the incident photons I1, the RTR 331 can reflect the incident photons I1 to produce reflected photons R1 that define a first spectral band. The coordinating agent compute device can receive the reflected photons R1 and can determine that the property values of the reflected photons R1 (e.g., an amplitude, a frequency, a time delay in receiving the reflected photons R1, etc.) match to property values stored at a memory of the coordinating agent compute device. The coordinating agent compute device can thereby verify that the first spectral band is included in an (expected) predefined sequence of spectral bands. A user and/or a motor/actuator of the mechanical modulator 300 (not shown in FIG. 3A) can move the panel 310 to a second position of the predefined sequence of positions such that the aperture 314 is disposed between the coordinating agent compute device and another retroreflector, such as the RTR 333 (as shown in FIG. 3B).

FIG. 3B is an example illustration of the mechanical modulator 300 of FIG. 3A at the second position of the predefined sequence of positions, according to an embodiment. The mechanical modulator 300 can receive the incident photons Il described in FIG. 3B at the RTR 333 through the aperture 314 of the absorptive surface 312 in response to a motion of the panel 310 to a second position of the predefined sequence of positions. In response to receiving the incident photons I1, the RTR 333 can reflect the incident photons I1 to produce reflected photons R2 that define a second spectral band. The coordinating agent compute device can receive the reflected photons R2 and can determine that the property values of the reflected photons R2 (e.g., an amplitude, a frequency, a time delay in receiving the reflected photons R2, etc.) match to property values stored at a memory of the coordinating agent compute device. The coordinating agent compute device can thereby verify that the second spectral band is included in an expected predefined sequence of spectral bands. In some implementations, a user and/or a motor/actuator of the mechanical modulator 300 (not shown in FIG. 3A) can move the panel 310 to a third position of a predefined sequence of positions such that the aperture 314 is disposed between the coordinating agent compute device and another retroreflector, such as the RTR 332 (not shown). The motion of the panel 310 as described in FIG. 3A to the first position and in FIG. 3B to the second position can continue until the panel 310 has been positioned at each position in the predefined sequence of positions, such that the coordinating agent compute device can verify the predefined sequence of spectral bands and therefore initiate communications (e.g., sending data) to the agent compute device.

While the mechanical modulator 300 shown in FIG. 3A and FIG. 3B has a circular shape, in some embodiments, the mechanical modulator 300 can have another shape, such as a rectangular shape. In some implementations, the panel 310 can have a rectangular shape, with an aperture disposed between each retroreflector fixed coupled to the base 320 and a coordinating agent compute device such that each retroreflector can receive incident energy/photons from the coordinating agent compute device through the aperture. In some implementations, the panel 310 can have an aperture disposed between more than one retroreflector fixed coupled to the base 320 and a coordinating agent compute device such that the more than one retroreflector can receive incident energy/photons from the coordinating agent compute device through the aperture. In some such implementations, the panel 310 can have, for example, absorptive material tiles covering one or more aperture(s). In some such implementations, each absorptive material tile can be movably coupled to the panel 310 such that a motion of the absorptive material tile can expose one or more retroreflector(s) to incident energy/photons (e.g., by removing the tile from the panel 310, by sliding the tile from one position on the panel 310 and to another position on the panel 310, and/or otherwise moving the tile to permit a transmission of incident energy/photons through the aperture).

While the mechanical modulator 300 shown in FIG. 3A and FIG. 3B has a panel 310 with one aperture, in some embodiments, the panel 310 can have more than one aperture such that one or more retroreflectors can receive incident energy/photons through the multiple apertures. In some such implementations, some positions of the panel 310 can expose more than one retroreflector through the multiple apertures while other positions of the panel 310 can expose one retroreflector through the multiple apertures.

In some embodiments, the panel 310 of the mechanical modulator 300 can have one or more retroreflector(s) disposed on a surface of the panel 310. In some such implementations, the one or more retroreflector(s) can reflect incident energy/photons regardless of a motion of the panel 310. In some such implementations, the mechanical modulator 300 can have retroreflectors fixed coupled to the base 320, as shown in FIG. 3A and FIG. 3B (e.g., the RTR 331, the RTR 332, and the RTR 333).

In some embodiments, the mechanical modulator 300 can have additional optics such as, for example, lenses, filters, prisms, and/or polarizers that can define additional modulations/ filtering of incident energy/photons. A coordinating agent compute device can predefine a pattern /sequence of any property values of energy/photons, based on the additional optics. In some such implementations, the mechanical modulator 300 can have, for example, neutral density filters disposed between the panel 310 and the retroreflectors (e.g., the RTR 331, the RTR 332, and/or the RTR 333). In some such implementations, each neutral density filter can have an optical density different from an optical density of other neural density filters that define an amplitude modulation of incident energy/photons (e.g., instead or in addition to an amplitude modulation of incident energy/photons defined by different reflection coefficient(s) of the retroreflectors). In some such implementations, for example, a coordinating agent compute device can define a predefined pattern(s) of amplitudes and can store a reference to the predefined pattern(s) of amplitudes as, for example, expected amplitude values at a memory of the agent compute device. In some such implementations, the coordinating agent compute device can send incident energy/ photons to the mechanical modulator 300. The optical density value(s) of neutral density filter(s) at the mechanical modulator 300 can define an amplitude modulation of the incident energy/photons, and the retroreflectors can reflect the incident energy/photons to produce reflected energy/photons. In some such implementations, the coordinating agent compute device can receive the reflected energy/photons having a pattern of amplitudes from the mechanical modulator 300. In some such implementations, the coordinating agent compute device can compare an amplitude value of received energy/photons to the expected amplitude values to verify a received pattern of amplitudes. In some such implementations, each retroreflector can have a spectral response that is substantially similar to the spectral response of other retroreflectors (e.g., substantially similar such that reflected energy/photons of a retroreflector do not exhibit a frequency modulation relative to incident energy/photons, or relative to reflected energy/photons of other retroreflectors).

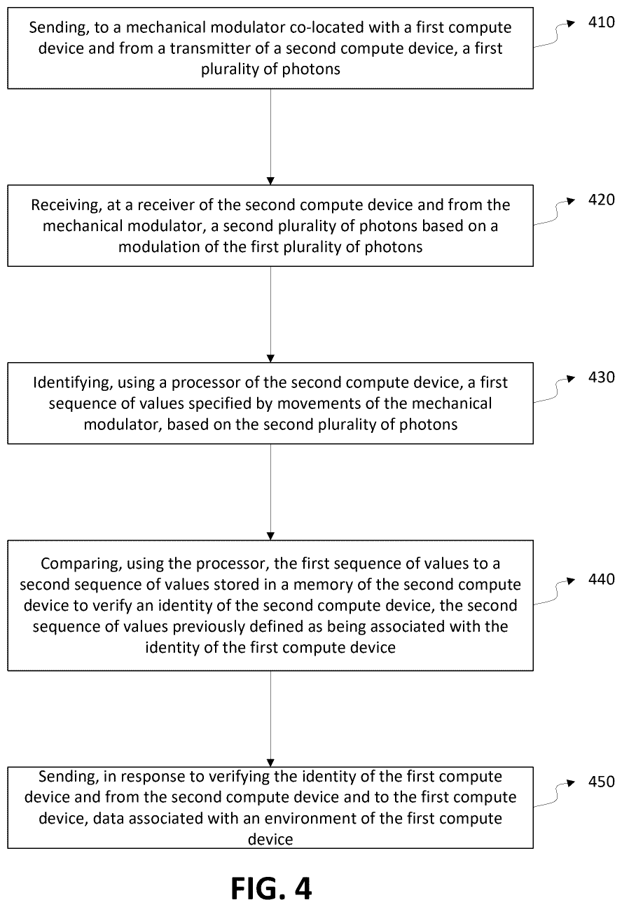

FIG. 4 is a flowchart of an example method 400 for a handshake, according to an embodiment. The example method 400 can be implemented by a coordinating agent compute device (e.g., the coordinating agent compute device 130 of FIG. 1). The handshake can be between the coordinating agent compute device and an agent compute device (e.g., the agent compute device 110 of FIG. 1) that is associated with and/or co-located with a mechanical modulator (e.g., the mechanical modulator 116 of FIG. 1) within an environment.

At 410, the example method 400 includes sending to a mechanical modulator co-located with a first compute device (e.g., the agent compute device 110 of FIG. 1) and from a transmitter of a second compute device (e.g., the coordinating agent compute device 130 of FIG. 1), a first plurality of photons. The first plurality of photons can have property values such as an amplitude, frequency, and/or the like. The second compute device can send the first plurality of photons through a directional cone of spectral energy towards the mechanical modulator and the first compute device.

At 420, the example method 400 includes receiving, at a receiver of the second compute device and from the mechanical modulator, a second plurality of photons based on a modulation of the first plurality of photons. The modulation of the first plurality of photons can include an amplitude modulation defined by reflection coefficient(s) of one or more retroreflector(s) of the mechanical modulator, a frequency modulation defined by frequency response(s) of one or more retroreflector(s) of the mechanical modulator, and/or a time modulation defined by a timing of a selection of the retroreflector(s) of the mechanical modulator (as caused by a motion of a panel of the mechanical modulator). The movements of the mechanical modulator can define the modulation of the first plurality of photons. The modulation of the first plurality of photons can define property values of the second plurality of photons, which can be different from the property values of the first plurality of photons. The second plurality of photons can define one or more spectral bands of a sequence of spectral bands. The second plurality of photons can thereby be a representation (e.g., a unique representation or otherwise) of an identity of the first compute device.

At 430, the example method 400 includes identifying, using a processor of the second compute device, a first sequence of values specified by movements of the mechanical modulator, based on the second plurality of photons. The first sequence of values can include a sequence of the property values of the second plurality of photons, such as, for example, a sequence of voltage(s), hertz, and/or any measurement units that can quantify amplitude(s), frequency, and/or the like of the second plurality of photons. The first sequence of values can represent the (measured) sequence of spectral bands. The processor of the second compute device can store the first sequence of values at a memory (e.g., the memory 134 of FIG. 1). For example, the processor of the second compute device can update a table of a database with entries for the first sequence of values.

At 440, the example method 400 includes comparing, using the processor, the first sequence of values to a second sequence of values stored in a memory of the second compute device to verify an identity of the second compute device, the second sequence of values previously defined as being associated with the identity of the first compute device. The second sequence of values can represent an (existing) predefined sequence of spectral bands, as stored at the memory. For example, the processor of the second compute device can have, before sending the first plurality of photons, defined the predefined sequence of spectral bands and stored the predefined property values of expected photons of each spectral band of the predefined sequence of spectral bands as entries of a table of the database. The processor can compare the first sequence of values to the second sequence of values to determine a substantial match and thereby verify the identity of the first compute device.

At 450, the example method 400 includes sending, in response to verifying the identity of the first compute device and from the second compute device and to the first compute device, data. In some instances, the data can be associated with the environment (e.g., information about the environment, a map of the environment, etc.). In some instances, the data can be or include new or updated instructions (e.g., instructions to change one or more objective(s) of a user/agent of the first compute device, etc.). In some instances, the data can be or include information relating to an objective of a user/agent of the first compute device (e.g., new information or not yet known information, etc.).

In some implementations, the data can be a map of the environment, and the example method 400 can further include generating, before sending the first plurality of photons, the map of the environment using the processor and based on sensor data of a sensor coupled to the second compute device.

In some implementations, the example method 400 can be stored as code and/or a set of instructions at the memory of the coordinating agent compute device and can be executed/ implemented by the processor of the coordinating agent compute device.

In some embodiments, an apparatus comprises: a mechanical modulator including a panel and a plurality of reflectors, the panel having a surface with an aperture, the surface having an absorptive material to substantially prevent a transmission of a first plurality of photons, the panel being moveable relative to the plurality of reflectors, the plurality of reflectors configured to receive the first plurality of photons through the aperture of the surface and to modulate the first plurality of photons in response to a motion of the panel to reflect a second plurality of photons through the aperture of the surface, the second plurality of photons being a representation of an identity of a first compute device co-located with the mechanical modulator within an environment, the first compute device configured to receive, from a second compute device, data at a memory operably coupled to a processor of the first compute device in response to the second compute device verifying the identity of the first compute device based on the second plurality of photons.

In some such implementations, each reflector from the plurality of reflectors is a retroreflector.

In some such implementations, at least one reflector from the plurality of reflectors modulates the first plurality of photons to produce the second plurality of photons.

In some such implementations, the data is a map of the environment, and the first compute device is configured to self-locate in the map of the environment based on sensor data of a sensor coupled to the first compute device.

In some such implementations, the first plurality of photons has a radio frequency, and the second plurality of photons has a radio frequency.

In some such implementations, each reflector from the plurality of reflectors has a reflection coefficient and a frequency response different from a reflection coefficient and a frequency response of the plurality of reflectors, the reflection coefficient of each reflector from the plurality of reflectors defining an amplitude modulation of the first plurality of photons and the frequency response of each reflector from the plurality of reflectors defining a frequency modulation of the first plurality of photons.

In some such implementations, the first compute device has an absence of Global Positioning System (GPS) signals in the environment.

In some such implementations, the second plurality of photons is a unique representation of the identity of the first compute device.

In some embodiments, a method comprises: sending, to a mechanical modulator co-located with a first compute device within an environment and from a transmitter of a second compute device, a first plurality of photons; receiving, at a receiver of the second compute device and from the mechanical modulator, a second plurality of photons based on a modulation of the first plurality of photons; identifying, using a processor of the second compute device, a first sequence of values specified by movements of the mechanical modulator, based on the second plurality of photons; comparing, using the processor, the first sequence of values to a second sequence of values stored in a memory of the second compute device to verify an identity of the second compute device, the second sequence of values previously defined as being associated with the identity of the first compute device; and sending, in response to verifying the identity of the first compute device and from the second compute device and to the first compute device, data.

In some such implementations, the data is a map of the environment, the method further comprises: generating, before sending the first plurality of photons, the map of the environment using the processor and based on sensor data of a sensor coupled to the second compute device.

In some such implementations, the first sequence of values and the second sequence of values include at least one of a position sequence or a time sequence.

In some such implementations, the second compute device is a compute device of a drone.

In some such implementations, the first compute device and the second compute device have an absence of Global Positioning System (GPS) signals in the environment.

In some such implementations, the first plurality of photons has a radio frequency, and the second plurality of photons has a radio frequency.

In some such implementations, the identity of the first compute device is unique to the first compute device and is not an identity of a third compute device.

In some such implementations, the second plurality of photons is based on at least one of an amplitude modulation, a frequency modulation, or a time modulation of the first plurality of photons that is within the environment.

In some embodiments, an apparatus comprises: a second compute device including: a transmitter, a receiver, a sensor, a processor, a memory that stores instructions that, when executed by the processor, causes the processor to: generate, based on sensor data from the sensor, a map of an environment; send, from the transmitter and to a mechanical modulator co-located with a first compute device, a first plurality of photons; receive, at the receiver and from the mechanical modulator, a second plurality of photons based on a modulation of the first plurality of photons; identify a first sequence of values specified by movements of the mechanical modulator based on the second plurality of photons; compare the first sequence of values to a second sequence of values to verify an identity of the first compute device, the second sequence of values previously defined as being associated with the identity of the first compute device; and send, in response to verifying the identity of the first compute device and to the first compute device, the map of the environment.

In some such implementations, the first plurality of photons has a radio frequency, and the second plurality of photons has a radio frequency.

In some such implementations, the mechanical modulator co-located with the first compute device is within the environment.

In some such implementations, the second compute device is a compute device of a drone.

Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using Python, Java, JavaScript, C++, and/or other programming languages and development tools. Additional examples of computer code include, but are not limited to, control signals, encrypted code, and compressed code.

The drawings primarily are for illustrative purposes and are not intended to limit the scope of the subject matter described herein. The drawings are not necessarily to scale; in some instances, various aspects of the subject matter disclosed herein can be shown exaggerated or enlarged in the drawings to facilitate an understanding of different features. In the drawings, like reference characters generally refer to like features (e.g., functionally similar and/or structurally similar elements).

The acts performed as part of a disclosed method(s) can be ordered in any suitable way. Accordingly, embodiments can be constructed in which processes or steps are executed in an order different than illustrated, which can include performing some steps or processes simultaneously, even though shown as sequential acts in illustrative embodiments. Put differently, it is to be understood that such features can not necessarily be limited to a particular order of execution, but rather, any number of threads, processes, services, servers, and/or the like that can execute serially, asynchronously, concurrently, in parallel, simultaneously, synchronously, and/or the like in a manner consistent with the disclosure. As such, some of these features can be mutually contradictory, in that they cannot be simultaneously present in a single embodiment. Similarly, some features are applicable to one aspect of the innovations, and inapplicable to others.

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Some embodiments described herein relate to a computer storage product with a non-transitory computer-readable medium (also can be referred to as a non-transitory processor-readable medium and/or a machine-readable medium) having instructions or computer code thereon for performing various computer-implemented operations. The computer-readable medium (or processor-readable medium, machine-readable medium, etc.) is non-transitory in the sense that it does not include transitory propagating signals per se (e.g., a propagating electromagnetic wave carrying information on a transmission medium such as space or a cable). The media and computer code (also can be referred to as code) can be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules can include, for example, a processor, a field programmable gate array (FPGA), and/or an application specific integrated circuit (ASIC). Software modules (executed on hardware) can include instructions stored in a memory that is operably coupled to a processor and can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

What is claimed is:

1. An apparatus, comprising:
a mechanical modulator including a panel and a plurality of reflectors, the panel having a surface with an aperture, the surface having an absorptive material to substantially prevent a transmission of a first plurality of photons, the panel being moveable relative to the plurality of reflectors,
the plurality of reflectors configured to receive the first plurality of photons through the aperture of the surface and to modulate the first plurality of photons in response to a motion of the panel to reflect a second plurality of photons through the aperture of the surface, the second plurality of photons being a representation of an identity of a first compute device co-located with the mechanical modulator within an environment,
the first compute device configured to receive, from a second compute device, data at a memory operably coupled to a processor of the first compute device in response to the second compute device verifying the identity of the first compute device based on the second plurality of photons.

2. The apparatus of claim 1, wherein each reflector from the plurality of reflectors is a retroreflector.

3. The apparatus of claim 1, wherein at least one reflector from the plurality of reflectors modulates the first plurality of photons to produce the second plurality of photons.

4. The apparatus of claim 1, wherein:
the data is a map of the environment, and
the first compute device is configured to self-locate in the map of the environment based on sensor data of a sensor coupled to the first compute device.

5. The apparatus of claim 1, wherein the first plurality of photons has a radio frequency and the second plurality of photons has a radio frequency.

6. The apparatus of claim 1, wherein each reflector from the plurality of reflectors has a reflection coefficient and a frequency response different from a reflection coefficient and a frequency response of the plurality of reflectors, the reflection coefficient of each reflector from the plurality of reflectors defining an amplitude modulation of the first plurality of photons and the frequency response of each reflector from the plurality of reflectors defining a frequency modulation of the first plurality of photons.

7. The apparatus of claim 1, wherein the first compute device has an absence of Global Positioning System (GPS) signals in the environment.

8. The apparatus of claim 1, wherein the second plurality of photons is a unique representation of the identity of the first compute device.

9. A method, comprising:
sending, to a mechanical modulator co-located with a first compute device within an environment and from a transmitter of a second compute device, a first plurality of photons;
receiving, at a receiver of the second compute device and from the mechanical modulator, a second plurality of photons based on a modulation of the first plurality of photons;
identifying, using a processor of the second compute device, a first sequence of values specified by movements of the mechanical modulator, based on the second plurality of photons;
comparing, using the processor, the first sequence of values to a second sequence of values stored in a memory of the second compute device to verify an identity of the second compute device, the second sequence of values previously defined as being associated with the identity of the first compute device; and
sending, in response to verifying the identity of the first compute device and from the second compute device and to the first compute device, data.

10. The method of claim 9, wherein the data is a map of the environment, the method further comprising:
generating, before sending the first plurality of photons, the map of the environment using the processor and based on sensor data of a sensor coupled to the second compute device.

11. The method of claim 9, wherein the first sequence of values and the second sequence of values include at least one of a position sequence or a time sequence.

12. The method of claim 9, wherein the second compute device is a compute device of a drone.

13. The method of claim 9, wherein the first compute device and the second compute device have an absence of Global Positioning System (GPS) signals in the environment.

14. The method of claim 9, wherein the first plurality of photons has a radio frequency and the second plurality of photons has a radio frequency.

15. The method of claim 9, wherein the identity of the first compute device is unique to the first compute device and is not an identity of a third compute device.

16. The method of claim 9, wherein the second plurality of photons is based on at least one of an amplitude modulation, a frequency modulation, or a time modulation of the first plurality of photons that is within the environment.

17. An apparatus, comprising:
a second compute device including:
a transmitter,
a receiver,
a sensor,
a processor,
a memory that stores instructions that, when executed by the processor, causes the processor to:
generate, based on sensor data from the sensor, a map of an environment;
send, from the transmitter and to a mechanical modulator co-located with a first compute device, a first plurality of photons;
receive, at the receiver and from the mechanical modulator, a second plurality of photons based on a modulation of the first plurality of photons;
identify a first sequence of values specified by movements of the mechanical modulator based on the second plurality of photons;
compare the first sequence of values to a second sequence of values to verify an identity of the first compute device, the second sequence of values previously defined as being associated with the identity of the first compute device; and
send, in response to verifying the identity of the first compute device and to the first compute device, the map of the environment.

18. The apparatus of claim 17, wherein the first plurality of photons has a radio frequency and the second plurality of photons has a radio frequency.

19. The apparatus of claim 17, wherein the mechanical modulator co-located with the first compute device is within the environment.

20. The apparatus of claim 17, wherein the second compute device is a compute device of a drone.
